(19) United States
(12) Patent Application Publication
(10) Pub. No.: US 2026/0135333 A1
(43) Pub. Date: May 14, 2026

(54) UNLOCKING ELASTIC PIECE WITH RESET ELASTIC ARM AND ELECTRICAL CONNECTOR HAVING THE SAME

(71) Applicant: DONGGUAN XUNTAO ELECTRONIC CO., LTD., Dongguan City (CN)

(72) Inventors: Xuzong HUANG, Dongguan City (CN); Sihai YI, Dongguan City (CN); Zhaolong ZENG, Dongguan City (CN); Kaide WANG, Dongguan City (CN)

(73) Assignee: DONGGUAN XUNTAO ELECTRONIC CO., LTD., Dongguan City (CN)

(21) Appl. No.: 19/050,774

(22) Filed: Feb. 11, 2025

(30) Foreign Application Priority Data
Nov. 12, 2024 (CN) 202422757166.X

(51) Int. Cl. H01R 13/633; H01R 13/627; H01R 13/639; H01R 13/66

(52) U.S. Cl. CPC H01R 13/6335; H01R 13/6275; H01R 13/639; H01R 13/6658

(57) ABSTRACT

An unlocking elastic piece includes a fixing portion, a locking portion, a connecting portion and a force-receiving portion. A space is formed between the locking portion and the fixing portion. The locking portion is provided with at least one locking protrusion configured to lock with a mating connector. The force-receiving portion is able to drive the locking portion to move closer to the fixing portion under an action of an external force, thereby causing the locking protrusion to be separated from the mating connector. The unlocking elastic piece further includes a reset elastic arm configured to drive the locking portion to move away from the fixing portion so as to realize the reset of the locking portion. An electrical connector having the unlocking elastic piece is also disclosed.

### CROSS-REFERENCE TO RELATED APPLICATION

This patent application claims priority of a Chinese Patent Application No. 202422757166.X, filed on Nov. 12, 2024 and titled “UNLOCKING ELASTIC PIECE AND ELECTRICAL CONNECTOR”, the entire content of which is incorporated herein by reference.

### TECHNICAL FIELD

The present disclosure relates to an unlocking elastic piece and an electrical connector, belonging to the technical field of connectors.

### BACKGROUND

Connector assemblies in the related art generally include an electrical connector and a mating connector for being mated with the electrical connector. The electrical connector includes an unlocking elastic piece. The unlocking elastic piece is provided with at least one locking protrusion. The mating connector defines at least one locking hole that matches the locking protrusion.

When it is necessary to unlock, an external force acting directly or indirectly on the unlocking elastic piece presses the unlocking elastic piece, causing the locking protrusion to be separated from the locking hole, thereby realizing unlocking between the electrical connector and the mating connector.

However, after being pressed multiple times, the elastic deformation ability of the unlocking elastic piece decreases, and locking/unlocking failure is prone to occur.

Therefore, it is desirable to improve the unlocking elastic piece in related technologies.

### SUMMARY

An object of the present disclosure is to provide a reliable unlocking elastic piece and an electrical connector having the unlocking elastic piece.

In order to achieve the above object, the present disclosure adopts the following technical solution: an unlocking elastic piece, including: a fixing portion, the fixing portion being configured to be installed on a first body of an electrical connector; a locking portion, the locking portion being spaced apart from the fixing portion, a space being formed between the locking portion and the fixing portion, the locking portion being provided with at least one locking protrusion configured to lock with a mating connector; a connecting portion, the connecting portion connecting one end of the fixing portion and one end of the locking portion; the fixing portion and the locking portion being located on a same side of the connecting portion; and a force-receiving portion, the force-receiving portion being connected to the locking portion, the force-receiving portion being configured to drive the locking portion to move closer to the fixing portion under an action of an external force, thereby causing the locking protrusion to be separated from the mating connector; wherein the unlocking elastic piece further includes a reset elastic arm that at least partially extends into the space; the reset elastic arm is configured to drive the locking portion to move away from the fixing portion so as to reset of the locking portion.

In order to achieve the above object, the present disclosure adopts the following technical solution: an electrical connector, including: a first body, the first body defining a mounting groove; and an unlocking elastic piece, including: a fixing portion configured to be installed on the first body; a locking portion spaced apart from the fixing portion, a space being formed between the locking portion and the fixing portion, the locking portion being provided with at least one locking protrusion configured to lock with a mating connector; a connecting portion connecting one end of the fixing portion and one end of the locking portion; the fixing portion and the locking portion being located on a same side of the connecting portion; and a force-receiving portion connected to the locking portion, the force-receiving portion being configured to drive the locking portion to move closer to the fixing portion under an action of an external force, thereby causing the locking protrusion to be separated from the mating connector; wherein the unlocking elastic piece further includes a reset elastic arm that at least partially extends into the space; the reset elastic arm is configured to drive the locking portion to move away from the fixing portion so as to reset of the locking portion.

Compared with the prior art, the electrical connector and the unlocking elastic piece of the present disclosure include a reset elastic arm that at least partially extends into the space. The reset elastic arm is configured to drive the locking portion to move away from the fixing portion to realize the reset of the locking portion. By providing the reset elastic arm, it is helpful to reduce the risk of fatigue failure of the locking portion due to being directly or indirectly pressed by an external force, and improve the reliability of locking and unlocking of the electrical connector and the mating connector.

### BRIEF DESCRIPTION OF DRAWINGS

FIG. 1 is a perspective schematic view of a connector assembly in accordance with an embodiment of the present disclosure;

FIG. 2 is an exploded perspective view of FIG. 1;

FIG. 3 is a partially exploded perspective view of the electrical connector in accordance with the embodiment of the present disclosure;

FIG. 4 is a perspective schematic view of an unlocking elastic piece in FIG. 3;

FIG. 5 is a perspective view of FIG. 4 from another angle;

FIG. 6 is a right view of FIG. 5;

FIG. 7 is a top view of FIG. 5;

FIG. 8 is a schematic cross-sectional view taken along line B-B in FIG. 7, in which the unlocking elastic piece is in a free state/reset state that is not affected by an external force;

FIG. 9 is a schematic cross-sectional view of another state in FIG. 8, wherein the unlocking elastic piece is in an unlocking state subject to the external force; and

FIG. 10 is a schematic cross-sectional view of FIG. 8 in accordance with another embodiment of the present disclosure.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

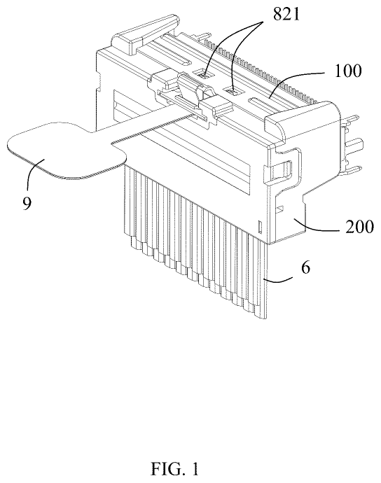

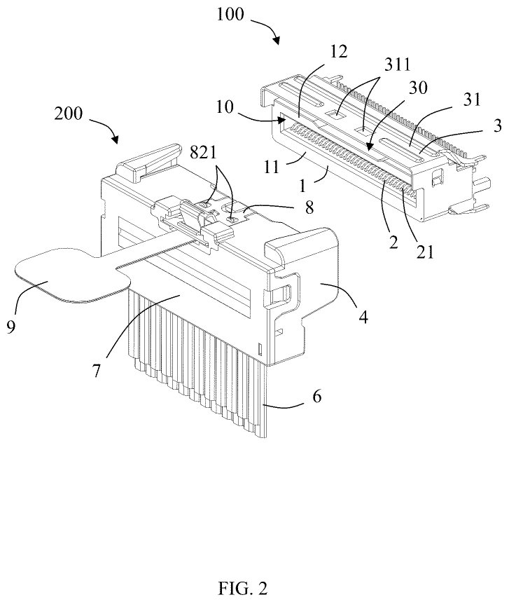

Referring to FIG. 1 and FIG. 2, the present disclosure discloses a connector assembly, which includes a mating connector 100 and an electrical connector 200 for being mated with the mating connector 100. In the illustrated embodiment of the present disclosure, the mating connector 100 is an SFP (Small Form-Factor Pluggable) receptacle connector. The electrical connector 200 is an SFP plug connector. Of course, it is understandable to those skilled in the art that the mating connector 100 and the electrical connector 200 can also be other types of electrical connectors.

Referring to FIG. 2, the mating connector 100 includes a mating insulating body 1, a plurality of mating conductive terminals 2 and a metal shielding shell 3. The mating insulating body 1 includes a mating surface 11 and an insertion slot 10 extending through the mating surface 11. Specifically, the mating insulating body 1 includes a top wall portion 12.

The mating conductive terminal 2 includes an elastic mating arm 21 extending into the insertion slot 10. In an embodiment of the present disclosure, the mating conductive terminals 2 are arranged in upper and lower rows. That is, the elastic mating arms 21 are arranged in the upper and lower rows, and extend into the insertion slot 10.

The metal shielding shell 3 includes an upper wall 31 located at an upper side of the top wall portion 12. The mating connector 100 includes a receiving cavity 30 located between the upper wall 31 and the top wall portion 12 in a top-bottom direction. The upper wall 31 defines two locking holes 311 spaced apart along a left-right direction for locking with the electrical connector 200.

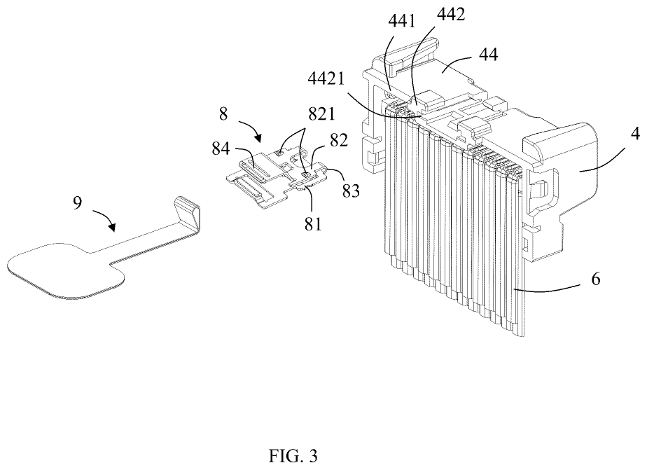

Referring to FIG. 2 and FIG. 3, the electrical connector 200 includes a first body 4, a conductive unit fixed to the first body 4, a plurality of cables 6 electrically connected to the conductive unit, a second insulating body 7 mated with the first body 4, an unlocking elastic piece 8 installed on the first body 4, and a pull strap 9 connected to the unlocking elastic piece 8. In the illustrated embodiment of the present disclosure, the first body 4 is a first insulating body, that is, it is made of insulating material. In the illustrated embodiment of the present disclosure, the conductive unit is a built-in circuit board. Of course, in other embodiments, the conductive unit may also be a conductive terminal or the like.

The first body 4 includes a top wall 44. The top wall 44 includes a rear end surface 441 and a mounting protrusion 442 protruding backwardly beyond the rear end surface 441. The mounting protrusion 442 includes a mounting groove 4421 extending backwardly. The unlocking elastic piece 8 is at least partially installed in the mounting groove 4421.

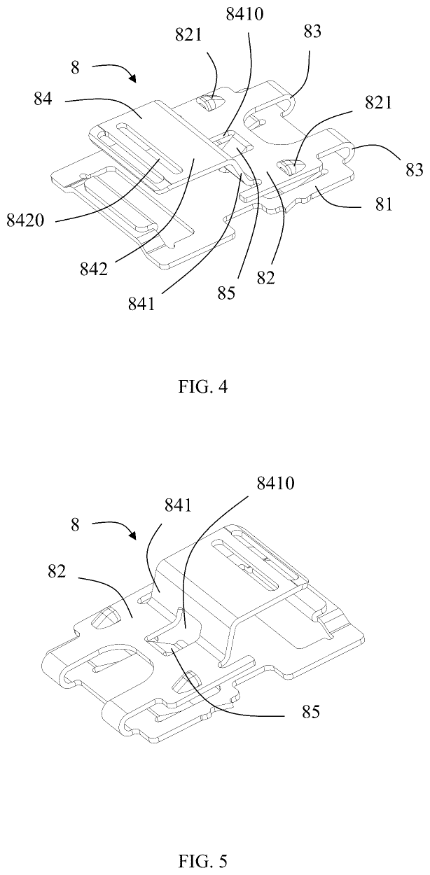

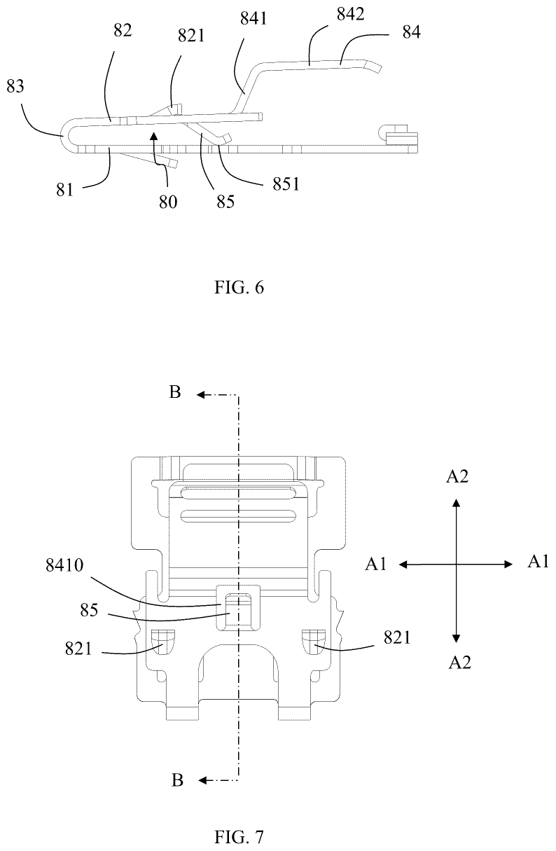

Referring to FIG. 4 to FIG. 9, in one embodiment of the present disclosure, the unlocking elastic piece 8 is made of metal material and is generally U-shaped. The unlocking elastic piece 8 includes a fixing portion 81, a locking portion 82 spaced apart from the fixing portion 81, a connecting portion 83 connecting one end of the fixing portion 81 and one end of the locking portion 82, and a force-receiving portion 84 connected with the locking portion 82. In the illustrated embodiment of the present disclosure, the fixing portion 81, the connecting portion 83 and the locking portion 82 are U-shaped as a whole. The fixing portion 81 and the locking portion 82 are located on a same side of the connecting portion 83. The fixing portion 81 is fixed in the mounting groove 4421 of the first body 4. The locking portion 82 is provided with at least one locking protrusion 821 which is configured to lock with the locking hole 311 of the mating connector 100. In the illustrated embodiment of the present disclosure, two locking protrusions 821 are provided and are spaced apart along a first direction A1-A1. In the illustrated embodiment of the present disclosure, the two locking protrusions 821 are integrally stamped from the locking portion 82, and the two locking protrusions 821 are in alignment with each other along the first direction A1-A1. The force-receiving portion 84 is able to directly or indirectly drive the locking portion 82 to move closer to the fixing portion 81 under an action of an external force, thereby causing the locking protrusion 821 to be separated from the locking hole 311 of the mating connector 100 to achieve unlocking. In the illustrated embodiment of the present disclosure, the connecting portion 83 is arc-shaped to better provide support for the deformation of the locking portion 82.

In the illustrated embodiment of the present disclosure, the locking portion 82 is spaced apart from the fixing portion 81. The locking portion 82 is located above the fixing portion 81. The unlocking elastic piece 8 includes a space 80 between the locking portion 82 and the fixing portion 81. The unlocking elastic piece 8 further includes a reset elastic arm 85 that at least partially extends into the space 80. The reset elastic arm 85 is configured to drive the locking portion 82 to move away from the fixing portion 81 in order to realize the reset of the locking portion 82.

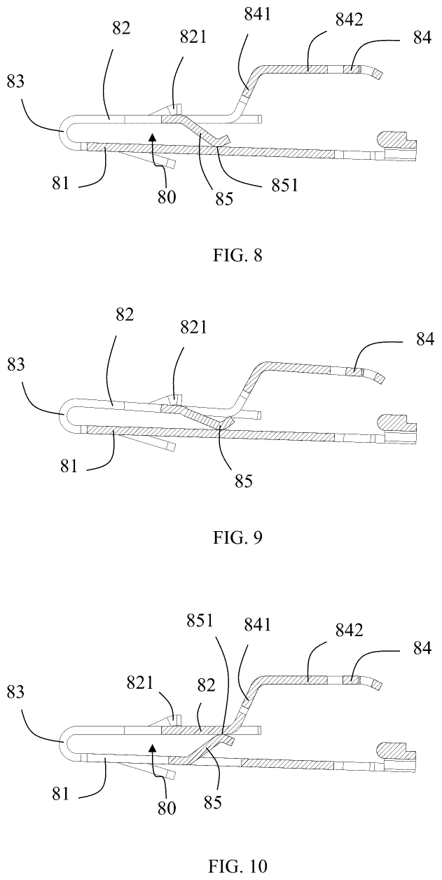

As shown in FIG. 8, in a first embodiment of the present disclosure, the reset elastic arm 85 is integrally stamped from the locking portion 82. The reset elastic arm 85 is configured to abut against the fixing portion 81 to provide a reset force for resetting the locking portion 82.

As shown in FIG. 10, in a second embodiment of the present disclosure, the reset elastic arm 85 is integrally stamped from the fixing portion 81. The reset elastic arm 85 is configured to abut against the locking portion 82 to provide a reset force for resetting the locking portion 82.

In the illustrated embodiment of the present disclosure, the reset elastic arm 85 extends obliquely away from the connecting portion 83. The reset elastic arm 85 is in a cantilever shape. The reset elastic arm 85 includes an arc-shaped contact surface 851 adjacent to a free end thereof. The arc-shaped contact surface 851 is used to abut against the fixing portion 81 in the above-mentioned first embodiment, or is used to abut against the locking portion 82 in the above-mentioned second embodiment, so as to reduce scratching as much as possible and improve the smoothness of contact.

In the illustrated embodiment of the present disclosure, the reset elastic arm 85 is located between the two locking protrusions 821 in the first direction A1-A1 (for example, the left-right direction). The two locking protrusions 821 are not aligned with the reset elastic arm 85 along the first direction A1-A1. In other words, the locking protrusion 821 and the reset elastic arm 85 are arranged one after the other along a second direction A2-A2 (for example, a front-rear direction). The second direction A2-A2 is perpendicular to the first direction A1-A1.

Specifically, in the illustrated embodiment of the present disclosure, the force-receiving portion 84 includes an inclined portion 841 connected to the locking portion 82 and an extension portion 842 connected to the inclined portion 841. The unlocking elastic piece 8 includes an opening 8410 left after the reset elastic arm 85 is stamped. The opening 8410 is located at a junction of the locking portion 82 and the inclined portion 841, and the opening 8410 is provided on the locking portion 82 and the inclined portion 841. With this arrangement, the inclined portion 841 can be used to adjust the length of the reset elastic arm 85. The extension portion 842 defines a slot 8420 and a buckle portion 8421 located beside the slot 8420. The buckle portion 8421 is configured to mate with the pull strap 9 which is at least partially located in the slot 8420.

When unlocking is required, an external force can be transferred to the force-receiving portion 84 by pulling the pull strap 9. The force-receiving portion 84 drives the locking portion 82 to move closer to the fixing portion 81 (for example, elastically deforms downwardly), so that the locking protrusion 821 is separated from the locking hole 311 of the mating connector 100 to achieve unlocking. At this time, the reset elastic arm 85 is compressed to generate a certain reset force on the locking portion 82. When the unlocking is completed and the external force is removed, the reset elastic arm 85 is reset, thereby driving the locking portion 82 to be reset.

Of course, it is understandable to those skilled in the art that the pull strap 9 may not even be provided in other embodiments of the electrical connector 200. When unlocking, the external force directly acts on the force-receiving portion 84, which is also able to achieve the purpose of unlocking.

It is understandable to those skilled in the art that by providing the reset elastic arm 85 in the present disclosure, on the one hand, it is helpful to prevent the locking portion 82 from being excessively pulled by an external force when unlocking, resulting in fatigue failure; on the other hand, it is beneficial to better reset the locking portion 82 when the external force is removed.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An unlocking elastic piece, comprising:
a fixing portion, the fixing portion being configured to be installed on a first body of an electrical connector;
a locking portion, the locking portion being spaced apart from the fixing portion, a space being formed between the locking portion and the fixing portion, the locking portion being provided with at least one locking protrusion configured to lock with a mating connector;
a connecting portion, the connecting portion connecting one end of the fixing portion and one end of the locking portion; the fixing portion and the locking portion being located on a same side of the connecting portion; and
a force-receiving portion, the force-receiving portion being connected to the locking portion, the force-receiving portion being configured to drive the locking portion to move closer to the fixing portion under an action of an external force, thereby causing the locking protrusion to be separated from the mating connector;
wherein the unlocking elastic piece further comprises a reset elastic arm that at least partially extends into the space; the reset elastic arm is configured to drive the locking portion to move away from the fixing portion so as to reset of the locking portion.

2. The unlocking elastic piece according to claim 1, wherein the reset elastic arm is integrally stamped from the locking portion; the reset elastic arm is configured to abut against the fixing portion in order to provide a reset force to reset the locking portion.

3. The unlocking elastic piece according to claim 1, wherein the reset elastic arm is integrally stamped from the fixing portion; the reset elastic arm is configured to abut against the locking portion in order to provide a reset force to reset the locking portion.

4. The unlocking elastic piece according to claim 1, wherein the fixing portion, the connecting portion and the locking portion are U-shaped as a whole; the reset elastic arm extends obliquely away from the connecting portion.

5. The unlocking elastic piece according to claim 1, wherein the reset elastic arm is in a cantilever shape; the reset elastic arm comprises an arc-shaped contact surface adjacent to a free end thereof.

6. The unlocking elastic piece according to claim 1, wherein two locking protrusions are provided and are spaced apart along a first direction; the reset elastic arm is located between the two locking protrusions in the first direction.

7. The unlocking elastic piece according to claim 6, wherein the two locking protrusions are in alignment with each other along the first direction; the two locking protrusions are not in alignment with the reset elastic arm along the first direction.

8. The unlocking elastic piece according to claim 1, wherein the force-receiving portion comprises an inclined portion connected to the locking portion and an extension portion connected to the inclined portion;
the unlocking elastic piece defines an opening left after stamping and forming the reset elastic arm; the opening is located at a junction of the locking portion and the inclined portion, and the opening is provided on the locking portion and the inclined portion.

9. The unlocking elastic piece according to claim 8, wherein the extension portion comprises a slot and a buckle portion located beside the slot; the buckle portion is configured to mate with a pull strap which is at least partially located in the slot.

10. An electrical connector, comprising:
a first body, the first body defining a mounting groove; and
an unlocking elastic piece, comprising:
a fixing portion configured to be installed on the first body;
a locking portion spaced apart from the fixing portion, a space being formed between the locking portion and the fixing portion, the locking portion being provided with at least one locking protrusion configured to lock with a mating connector;
a connecting portion connecting one end of the fixing portion and one end of the locking portion; the fixing portion and the locking portion being located on a same side of the connecting portion; and
a force-receiving portion connected to the locking portion, the force-receiving portion being configured to drive the locking portion to move closer to the fixing portion under an action of an external force, thereby causing the locking protrusion to be separated from the mating connector;
wherein the unlocking elastic piece further comprises a reset elastic arm that at least partially extends into the space; the reset elastic arm is configured to drive the locking portion to move away from the fixing portion so as to reset of the locking portion.

11. The electrical connector according to claim 10, wherein the reset elastic arm is integrally stamped from the locking portion; the reset elastic arm is configured to abut against the fixing portion in order to provide a reset force to reset the locking portion.

12. The electrical connector according to claim 10, wherein the reset elastic arm is integrally stamped from the fixing portion; the reset elastic arm is configured to abut against the locking portion in order to provide a reset force to reset the locking portion.

13. The electrical connector according to claim 10, wherein the fixing portion, the connecting portion and the locking portion are U-shaped as a whole; the reset elastic arm extends obliquely away from the connecting portion.

14. The electrical connector according to claim 10, wherein the reset elastic arm is in a cantilever shape; the reset elastic arm comprises an arc-shaped contact surface adjacent to a free end thereof.

15. The electrical connector according to claim 10, wherein two locking protrusions are provided and are spaced apart along a first direction; the reset elastic arm is located between the two locking protrusions in the first direction.

16. The electrical connector according to claim 15, wherein the two locking protrusions are in alignment with each other along the first direction; the two locking protrusions are not in alignment with the reset elastic arm along the first direction.

17. The electrical connector according to claim 10, wherein the force-receiving portion comprises an inclined portion connected to the locking portion and an extension portion connected to the inclined portion;
the unlocking elastic piece defines an opening left after stamping and forming the reset elastic arm; the opening is located at a junction of the locking portion and the inclined portion, and the opening is provided on the locking portion and the inclined portion.

18. The electrical connector according to claim 17, wherein the extension portion comprises a slot and a buckle portion located beside the slot; the buckle portion is configured to mate with a pull strap which is at least partially located in the slot.

19. The electrical connector according to claim 10, further comprising a conductive unit fixed to the first body and a plurality of cables electrically connected to the conductive unit.

20. The electrical connector according to claim 19, wherein the conductive unit is a built-in circuit board.
